(19) United States
(12) Patent Application Publication
(10) Pub. No.: US 2004/0264180 A1
(43) Pub. Date: Dec. 30, 2004

(54) Adjustable task light

(76) Inventor: Edmund Chan, EL Cerrito, CA (US)

Correspondence Address: EDMUND CHAN, 2114 JUNCTION AV., EL CERRITO, CA, 94530-1730, US

(21) Appl. No.: 10/608,568

(22) Filed: Jun. 26, 2003

(51) Int. Cl. F21L 2/00

(52) U.S. Cl. 362/157

(57) ABSTRACT

Adjustable Task Light comprising a housing assembly, an electrical cable, a magnet, a lamp and a lamp shade. The housing bottom internally supports four perpendicularly disposed posts. One post is capable of rotatably retaining a centrally located roller wheel. Three remaining posts capable of retaining three additional wheel shaped retainers. Two retainers are made of rigid material and one the wheel retainer made of a resilient material. The central wheel and the additional wheel retainers are positioned in such a way that they can slidably retain the electrical cable in a fixed position. The cable terminates on one end in a lamp assembly, and on the opposite end in a wall pack transformer. The housing includes a flange with a post which retains a standard hook member. The housing cover plate retains a standard magnet.

### CROSS REFERENCE TO RELATED APPLICATIONS

Not Applicable

### STATEMENT REGARDING FEDERALLY RESEARCH OR DEVELOPMENT

Not Applicable

### DESCRIPTION OF ATTACHED APPENDIX

Not Applicable

### BACKGROUND OF THE INVENTION

This invention relates generally to the field of portable lighting devices and more specifically to an adjustable task light. Various types of task lights are well known. Specific lighting requirements often require unusual methods of positioning a lamp or holding a lamp assembly. One known type of task light is used when working in an otherwise dark environment such as a garage. The garage task light is comprised of an incandescent bulb housing having a hook member attached so that the user can hang the light from a portion of the raised hood of a vehicle and thereby illuminate the engine compartment of a vehicle. Other task lights may use magnets in their housings to help hold an incandescent light or fluorescent light onto the surface of a ferrous material such as the hood of a vehicle. Still other task lights use a spring biased clamp or clip to help hold the lamp assembly onto the edge of a panel or pole such as the edge of a table or the like. Although existing task lights are useful in helping people illuminate difficult areas, they poses certain deficiencies. Currently, no one specific task light can be easily adapted to a variety environmental conditions. No one task light includes the ability to be attached by a hook or by a magnet or clamp while having the ability to adjust the height of the light source with relation to the holding means.

### BRIEF SUMMARY OF THE INVENTION

The primary object of the invention is to provide a task light that allows the user to set the light at different heights.

Another object of the invention is to provide a task light that allows the user to removably attach the light into structures such as the raised hood of a vehicle or the like.

Another object of the invention is to provide a task light whose height can be raised or lowered to a set position by the user pulling on the lamp's cable with respect to the lamps cable housing.

A further object of the invention is to provide a task light whose height can be adjusted without the need to tighten or loosen a cable clamping means.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed adjustable task light comprising: a triangular shaped main housing, a housing cover, an electrical cable, a magnet, a lamp and a lamp socket. Said main body having a flat bottom and an integral side surrounding wall and an integral perpendicularly disposed flange extending outwardly from the outside of the flat portion of said flat bottom. Said flat bottom internally supporting four perpendicularly disposed posts, one said post capable of rotatably retaining a centrally located roller wheel, three said remaining posts located near the three corners of said flat bottom of said triangular main housing. Said three posts capable of retaining wheel shaped rotatable retainers, two said wheel retainers made of rigid material and one said wheel retainer made of a resilient material such as felt or rubber or the like. Said central wheel and said additional wheel retainers positioned in such a way that they can slidably retain said electrical cable which is round its outer cross section. Said housing cover enclosing said central wheel and said retaining wheels and held in place by screws that mate with threads located in the top of said wheel retaining posts. Said cable terminating on one end in a lamp socket and associated lamp and lamp shade, and on the opposite end in an AC to DC wall pack transformer or battery pack. Said housing flange including a post which rotatably retains a standard hook member. Said housing cover plate being made of rigid material such as plastic or metal and having an integral frame portion capable of retaining a standard magnet.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a front view of the invention.

FIG. 3 is a partial front view of the invention with the housing cover removed,

FIG. 4 is is a top section view of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

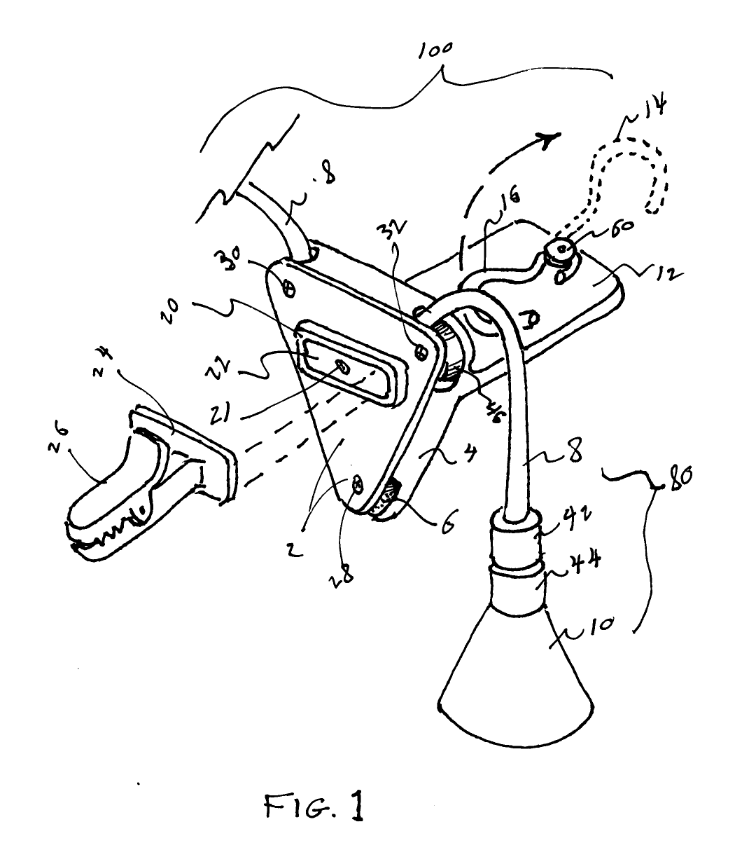

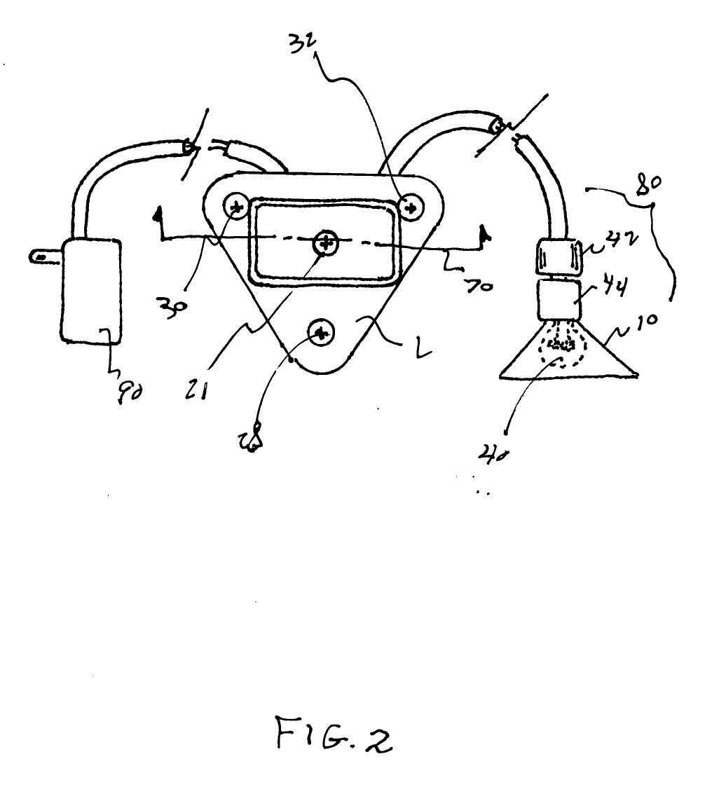

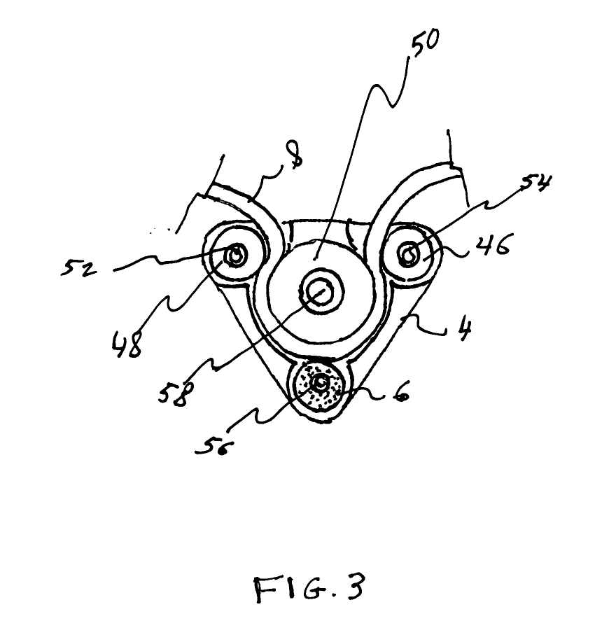

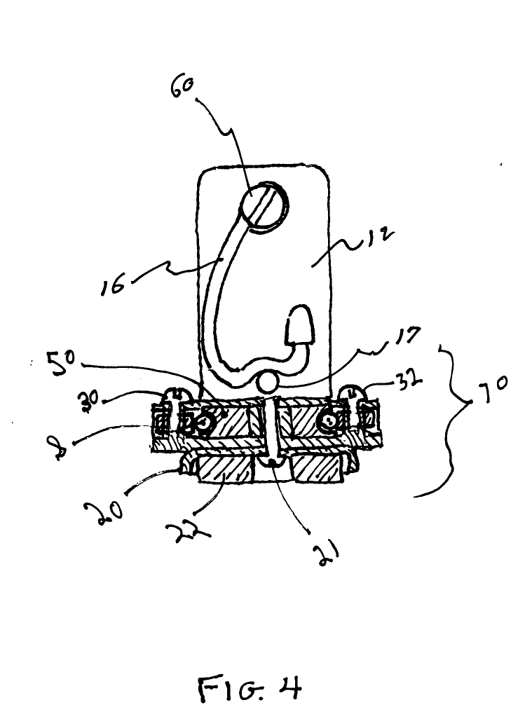

Referring now to FIG. 1 we see a perspective view of the task light of the present invention 100. A main triangular housing 4 and housing cover 2 encloses four retaining wheels 6, 48, 46, 50 which are centrally and rotatably held by posts 56, 52, 58, 54 shown in FIG. 3. The retaining wheels slidably retain cable 8. Cable 8 terminates at one end in a lamp assembly 80 and at the opposite end in an AC to DC wall pack transformer 90 as shown in FIG. 2. Alternately, lighting assembly 80 can be powered by a battery type power source housed in a standard battery holding enclosure. Retaining wheel 6 is made of resilient material such as rubber or felt or the like. Retaining wheels 46, 48 are made of rigid material such as metal or plastic. Central retaining wheel 50 has a concave side wall as shown by section view 70 in FIG. 4. Cable 8 is round in cross section as shown in FIG. 4. A user can pull on cable 8 which causes the cable to frictionally slide forward or backward thereby causing the lamp assembly 80 to hang higher or lower from housing assembly 4. Because of the circuitous route cable 8 takes through housing 4 and because of the resistance that resilient retaining wheel produces on cable 8, the lamp assembly remains in a fixed position in relation to housing 4 after the cable 8 is slid one way or the other by the user. In this way a user can adjust the height of the lamp assembly 80 with respect to housing 4. Triangular housing 4 includes an integral flange 12 that supports a post 60 and rotatable hook 16 whose rotation is shown by dotted line 14. This hook 16 can be used to hang the housing 2,4 from any aperture or the like such as the apertures located in the structural portion under the hood of a vehicle. Alternately, the user may attach housing 2,4 to a ferrous material by use of magnet 22 which is held in place on cover plate 2 by surrounding wall 20 and retaining screw 21. A third means of removable attachment can be accomplished by attaching clamping assembly 26, which has a ferrous back plate 24, to magnet 22 located on housing cover 2. The clamping assembly 26 can be used on the edge of a structural member. Housing cover 2 is held in place by screws 28, 30, 32 which mate with the threaded female portions located on top of wheel retaining posts 52, 58, 56, 54. Lamp assembly 80 is comprised of lamp socket 42, lamp base 44, incandescent lamp bulb 40 and lamp shade 10. Since lamp socket 44 is removable and replaceable from socket 42, a variety of lamps and shades can be interchanged depending on the lighting conditions and space conditions desired by the user. An on-off switch may be added to the cable to increase ease of use. FIG. 4 shows that hook 16 may be removably retained by post 17.

In the above illustrated and described way, a person can use the unique task light of the present invention, can easily hang the task light to illuminate areas such as the engine compartment of a vehicle or the like and can easily adjust the height of the lamp assemble as desired.

Obviously, the present invention can be used in a variety of applications including overhead lighting in a home or office.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Adjustable Task Light comprising: a triangular shaped main housing, a flat housing cover, an electrical cable, a magnet, a lamp, a lamp socket;
said main body having a flat bottom and an integral side surrounding wall and an integral perpendicularly disposed flange extending outwardly from the outside of the flat portion of said flat bottom, said flat bottom internally supporting four perpendicularly disposed posts, one said post capable of centrally and rotatably retaining a centrally located roller wheel; three said remaining posts located near the three corners of said flat bottom of said triangular main housing;
said three posts capable of retaining wheel shaped rotatable retainers;
two said wheel retainers made of rigid material and one said wheel retainer made of a resilient material such as felt or rubber or the like;
said central wheel and said additional wheel retainers positioned in such a way that they can slidably retain said electrical cable which is round its outer cross section;
said housing cover enclosing said central wheel and said retaining wheels and held in place by screws that mate with threads located in the top of said wheel retaining posts;
said cable terminating on one end in a lamp socket and associated lamp and lamp shade, and on the opposite end in an AC to DC wall pack transformer;
said housing flange including a post which rotatably retains a standard hook member;
and said housing cover plate being made of rigid material such as plastic or metal and having an integral frame portion capable of retaining a standard magnet.

2. Adjustable Task Light as claimed in claim 1 wherein said retainer wheel which is made of resilient material is capable of frictionally retaining said cable so that when a user slides said main housing to the left or right, the said lamp can hang higher or lower and remain in position until the user slides said housing to a different location.]

3. Adjustable Task Light as claimed in claim 1 further comprising a spring biased clip that has a ferrous metal plate fixedly attached and that is comparable in size to the said magnet located on the outside of said housing cover so that the user can mount said task light via said clip rather than be said rotatable hook.

4. Adjustable Task Light as claimed in claim 1 wherein said task light assembly is compact and therefore has less chance of interfering with the user's ability to perform a task.

5. Adjustable Task Light as claimed in claim 1 wherein said lamp is powered by a battery power source.
